(19) United States
(12) Patent Application Publication
(10) Pub. No.: US 2010/0243160 A1
(43) Pub. Date: Sep. 30, 2010

(54) METHOD OF PRODUCING RECORDING MEDIUM

(75) Inventors: Ryoichi NAKANO, Kanagawa (JP); Jun NAITO, Kanagawa (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/749,537

(22) Filed: Mar. 30, 2010

(30) Foreign Application Priority Data
Mar. 31, 2009 (JP) 2009-088372
Jan. 13, 2010 (JP) 2010-004947

(51) Int. Cl. B29C 63/00

(52) U.S. Cl. 156/344

(57) ABSTRACT

A method of producing a recording medium includes: providing a substrate, the substrate including a resin layer containing a polyolefin resin formed on one or both sides of a base paper; subjecting a resin layer-side surface of the substrate to a cooling-separation treatment using a cooling-separation belt-fixing smoother apparatus, the apparatus including a heating and pressurizing unit and the unit including a belt member, by applying heat and pressure to the surface at a temperature of at least 80° C. and less than 140° C. using the heating and pressurizing unit, cooling the surface to a temperature of 60° C. or lower, and separating the surface from the belt member; and forming an image recording layer on the resin layer-side surface of the substrate.

### CROSS-REFERENCE TO RELATED APPLICATIONS

This application claims priority under 35 USC 119 from Japanese Patent Application Nos. 2009-088372 filed on Mar. 31, 2009 and 2010-004947 filed on Jan. 13, 2010, the disclosures of which are incorporated by reference herein.

### BACKGROUND OF THE INVENTION

1. Field of the Invention

The present invention relates to a method of producing a recording medium.

2. Description of the Related Art

Many proposals have been made regarding the application of heat and pressure treatment to recording media including a thermoplastic resin so as to improve smoothness and glossiness of the surface of printed matter.

For example, (1) an image forming method in which an image is formed on a recording medium having a porous surface layer containing a thermoplastic resin and then pressure is applied while heating to make the surface smooth (see, for example, Japanese Patent No. 3703325) and (2) a recording method in which recording is performed by applying ink droplets onto a recording medium having a laminate material layer for forming a laminate layer and then a laminate layer is formed by applying heat and pressure (see, for example, Japanese Patent No. 2908518), have been proposed.

Further, proposals have also been made to make the surface of a recording medium smooth and glossy before recording an image. For example, (3) a manufacturing method in which a recording medium having a resin layer containing a polyolefin resin is subjected to a smoothing treatment by applying heat and pressure using a belt fixing smoother apparatus utilizing a cooling-separation system has been described (see, for example, Japanese Patent Application Laid-Open (JP-A) Nos. 2005-153263 and 2004-114447).

Manufacturing examples using the smoothing treatment described in JP-A Nos. 2005-153263 and 2004-114447 are further explained in detail below.

The manufacturing examples of an inkjet recording medium described in Examples 1 to 3 and 5 of JP-A No. 2005-153263 include providing resin layers on both sides of a substrate paper, forming an ink receiving layer on one of the resin layers having a highly glossy surface, and subjecting the ink receiving layer to the smoothing treatment.

The manufacturing example of an image forming or image fixing material described in Example 1 of JP-A No. 2004-114447 includes providing polyethylene resin layers on both sides of a base paper, and subjecting one of the polyethylene resin layers, which is the polyethylene resin layer that will serve as a toner image receiving layer, to the smoothing treatment.

Further, the manufacturing example of a color photographic paper (silver salt photographic printing material) described in Example 2 of JP-A No. 2004-114447 includes using a paper sheet prepared by disposing polyethylene resin layers on both sides of a base paper to provide a substrate, providing an emulsion layer on one side of the substrate, and subjecting the emulsion layer to the smoothing treatment.

Each of the manufacturing examples involves subjecting an image recording layer to the smoothing treatment. However, the manufacturing examples do not involve forming an image recording layer on a resin layer that has already been subjected to the smoothing treatment.

There have been many proposals for improving the smoothness and glossiness of the surface of a printed matter or recording medium, as described above.

However, the methods described in Japanese Patent Nos. 3703325 and 2908518 are methods utilizing a processing system in which processing is performed after a recording image has been formed on a recording medium. Therefore, a device for applying heat and pressure needs be provided in the recording device or as a subsequent device. This means that it is necessary to provide a considerable amount of additional machinery, as a result of which the method have a limited range of application.

Moreover, the methods described in JP-A Nos. 2005-153263 and 2004-114447 are methods of subjecting an image recording layer to the smoothing treatment. Since the smoothing treatment sometimes impairs the performance of the image recording layer, the smoothing treatment should be performed under conditions that cause less deterioration in performance. In addition, when the smoothing treatment is not directly applied to a resin layer disposed below an image recording layer, there is still room for improvement in glossiness and image clarity.

### SUMMARY OF THE INVENTION

The present invention has been made in view of the above circumstances and provides a method of producing a recording medium.

According to a first aspect of the invention, there is provided a method of producing a recording medium, the method including:
providing a substrate, the substrate including a resin layer containing a polyolefin resin formed on one or both sides of a base paper;
subjecting a resin layer-side surface of the substrate to a cooling-separation treatment using a cooling-separation belt-fixing smoother apparatus, the apparatus including a heating and pressurizing unit and the unit including a belt member, by:
   applying heat and pressure to the surface at a temperature of at least 80° C. and less than 140° C. using the heating and pressurizing unit;
   cooling the surface to a temperature of 60° C. or lower; and
   separating the surface from the belt member; and
forming an image recording layer on the resin layer-side surface of the substrate.

### BRIEF DESCRIPTION OF THE DRAWINGS

FIG. 1 is a schematic diagram showing an example of a cooling-separation treatment using a cooling-separation-belt-fixing smoother apparatus for the method of producing a recording medium of the present invention.

### DETAILED DESCRIPTION OF THE INVENTION

In the following, a method of producing a recording medium is described in detail. A method of producing a recording medium according to the present invention includes: forming an image recording layer on a substrate, the substrate comprising a resin layer containing a polyolefin resin formed on one or both sides of a base paper and the image recording layer being formed on a resin layer-side surface of the substrate, wherein the resin layer-side surface of the substrate has been subjected to cooling-separation treatment by applying heat and pressure to the surface at a temperature of at least 80° C. and less than 140° C. using a heating and pressurizing unit in a cooling-separation-belt-fixing-smoother apparatus, cooling the surface to a temperature of 60° C. or lower, and then separating the surface from a belt member of the heating and pressurizing unit.

Specifically, in the present invention, the substrate includes a resin layer (hereinafter, referred to as a “polyolefin resin layer” in some cases) containing a polyolefin resin (preferably as a main component). The method of the present invention includes smoothing a surface of the substrate that has the resin layer by cooling-separation treatment using a cooling-separation system belt fixing type smoothing apparatus, and forming an image recording layer on the smoothened surface, as a result of which a recording medium having excellent surface gloss, excellent image clarity, and reduced surface defects is obtained.

Here, the term “main component” refers to a component contained at a ratio of 60% by mass or higher with respect to the total solid content of the polyolefin resin layer.

Accordingly, in an embodiment, a method of producing a recording medium comprises:

providing a substrate, the substrate comprising a resin layer containing a polyolefin resin formed on one or both sides of a base paper;

subjecting a resin layer-side surface of the substrate to a cooling-separation treatment using a cooling-separation belt-fixing smoother apparatus, the apparatus comprising a heating and pressurizing unit and the unit comprising a belt member, by:
applying heat and pressure to the resin layer-side surface at a temperature of at least 80° C. but less than 140° C. using the heating and pressurizing unit;
cooling the resin layer-side surface to a temperature of 60° C. or lower; and
separating the resin layer-side surface from the belt member; and
forming an image recording layer on the resin layer-side surface of the substrate.

There is no particular limitation on actual embodiments and uses of the recording medium according to the present invention. The recording medium according to the present invention may suitably be used for various applications in which recording media having a paper substrate are used, and which require one or more of water resistance, surface smoothness, glossiness, or image clarity. Specifically, the recording medium according to the present invention may used as an inkjet recording medium, a printing paper, a silver-salt photographic paper, a thermal color-forming material, a sublimation transfer image-receiving material, or the like.

Concerning the surface gloss of the recording medium, the 60 degree gloss of the image recording layer-side of the recording medium is preferably 30% or more, more preferably 40% or more, and even more preferably 50% or more. The 60 degree gloss is measured at an incident angle of 60° and a light reception angle of 60°, using a digital variable gloss meter.

Concerning the image clarity of the recording medium, the measured value of the image clarity of the image recording layer-side of the recording medium is preferably 70% or more, and more preferably 80% or more, when measured in accordance with the image clarity test method defined in Japanese Industrial Standards (JIS) H8686-2: 1999, which is incorporated herein by reference, under the following measurement conditions. Measurement mode: reflection; measurement angle: 60°; and optical comb: 2.0 mm. JIS H8686-2: 1999 substantially corresponds to ISO 10216:1992.

<Substrate>

The substrate in the present invention has a polyolefin resin layer on one or both sides of a base paper. In other words, the substrate includes a first polyolefin resin layer provided on a first surface of the base paper, and may further include a second polyolefin resin layer, the composition of which may be the same as or different from the first polyolefin layer, provided on a second surface of the base paper. As long as the substrate has a polyolefin resin layer on one or both sides of a base paper, the polyolefin resin layer is not necessarily an outermost layer of the substrate, and may be, for example, an intermediate layer other than the outermost layer. The polyolefin resin layer is preferably an outermost layer of the substrate from the viewpoints of glossiness and image clarity.

In the method of producing a recording medium of the present invention, an image recording layer is formed on a surface at a side at which a polyolefin resin layer (i.e., first polyolefin resin layer) is provided and which has been smoothened by the cooling-separation treatment. The substrate preferably has a polyolefin resin layer on both sides of the base paper such that, in addition to the first polyolefin resin layer provided on the first surface at a side at which an image recording layer is to be provided, a second polyolefin layer is provided on the second surface at a side opposite to the first surface, in view of water resistance. Concerning the water absorption, specifically, the substrate preferably has a water absorption degree in terms of Cobb size of 5 g/m² or lower, more preferably 2 g/m² or lower, and even more preferably 1 g/m² or lower. The Cobb size water absorption degree is a value obtained by measuring the amount of water absorbed when a sample is contacted with pure water for 30 seconds, in accordance with JIS P8140, which is incorporated herein by reference. JIS P8140 substantially corresponds to ISO 535:1991.

It is preferred that the substrate includes the first and second polyolefin resin layers provided on the first and second surfaces of the base paper, and that the substrate further includes a pigment-containing layer provided on the second polyolefin resin layer at one side of the substrate. In this case, the image recording layer is formed on a surface at a side at which the pigment-containing layer is not provided. The substrate may also include at least one other layer provided between the second polyolefin resin layer and the pigment-containing layer, as needed. The at least one other layer may be suitably selected depending on the applications of the recording medium described below. When a positional relationship between layers is expressed by using the terms “upper” and “lower”, a layer that is closer to the base paper is expressed as a “lower” layer, and a layer that is farther from the base paper is expressed as an “upper” layer.

When the substrate includes the pigment-containing layer, it is preferred that the substrate includes the pigment-containing layer as an outermost layer, from the viewpoints of blocking resistance at the time of image recording and transportability of the recording medium in an image recording apparatus.

Base Paper

The main raw material of the base paper in the present invention may be a wood pulp. When making the base paper, at least one of synthetic pulp such as polypropylene, or synthetic fiber such as nylon or polyester may be optionally used in addition to the wood pulp. Any of LBKP, LBSP, NBKP, NBSP, LDP, NDP, LUKP, or NUKP may be used as the wood pulp. It is preferable to increase the total amount of LBKP, NBSP, LBSP, NDP and LDP, which have high contents of short fibers. However, the proportion of LBSP and/or LDP is preferably from 10% by mass to 70% by mass.

The pulp is preferably a chemical pulp (such as sulfate pulp or sulfite pulp) which has a less impurity content. A pulp of which whiteness has been improved by bleaching treatment is also useful.

One or more of the following agents may be appropriately added into the base paper as necessary: a sizing agent such as a high fatty acid or an alkylketene dimer, a white pigment such as calcium carbonate, talc, or titanium oxide, a paper-strength enhancing agent such as starch, polyacrylamide, or polyvinyl alcohol, a fluorescent whitening agent, a moisturizing agent such as a polyethylene glycol, a dispersant, a softener such as quaternary ammonium, or the like.

The freeness of the pulp used for paper-making is preferably from 200 mL to 500 mL in terms of C.S.F (Canadian Standard Freeness). Further, concerning the fiber length after beating, the sum of the percentage by mass of the pulp remaining on a 24-mesh screen and the percentage by mass of the pulp remaining on a 42-mesh screen according to JIS P-8207 (which is incorporated herein by reference) is preferably from 30% by mass to 70% by mass. In addition, the percentage by mass of the pulp remaining on a 4-mesh screen is preferably 20% by mass or less.

The basis weight of the base paper is preferably from 30 g/m² to 250 g/m², and particularly preferably from 50 g/m² to 200 g/m². The thickness of the base paper is preferably from 40 μm to 250 μm. High smoothness may also be rendered to the base paper by subjecting the base paper to calender treatment during or after paper-making. The density of the base paper is generally from 0.7 g/cm³ to 1.2 g/cm³ (according to JIS P8118, which is incorporated herein by reference). JIS 8118 substantially corresponds to ISO 534:1988. Furthermore, the stiffness of the base paper is preferably from 20 g to 200 g under the conditions according to JIS P8143, which is incorporated herein by reference.

The surface of the base paper may be coated with a surface sizing agent. A sizing agent may be selected from sizing agents that can be added to the interior of the base paper.

The pH of the base paper is preferably from 5 to 9, when measured in accordance with the hydrothermal extraction method defined by JIS P8113, which is incorporated herein by reference. JIS P8113 is equivalent to ISO 1924-2:1994.

Moreover, one or both sides of the base paper may be subjected to various kinds of surface treatments or undercoat treatments for the purpose of improving adhesion with the layer to be disposed thereon. Examples of the surface treatment include a patterning treatment, such as a gloss surface treatment, a fine surface treatment described in JP-A No. 55-26507, a matte surface treatment, or a silky surface treatment, and an activation treatment such as a corona discharge treatment, a flame treatment, a glow discharge treatment, or a plasma treatment. Examples of the undercoat treatment include the methods such as those described in JP-A No. 61-846443.

Each of these surface treatments may be performed singly, or may be arbitrarily combined with at least one other surface treatment. For example, an activation treatment may be performed after performing a patterning treatment or the like; or an undercoat treatment may be performed after performing an activation treatment or the like.

Even when a base paper that has not been subjected to a smoothing treatment is used, the surface gloss and image clarity are improved by performing the cooling-separation treatment described above due to the smoothing effect. Further, the surface gloss and image clarity are improved by the cooling-separation treatment due to the smoothing effect thereof, even when a polyolefin resin layer is formed on a base paper that has not been subjected to a smoothing treatment and the amount of polyolefin in the polyolefin resin layer is relatively small. Here, the surface roughness (center plane average roughness (SRa value)) of the base paper that has not been subjected to a smoothing treatment is preferably from about 0.05 μm to about 0.5 μm, and more preferably from 0.1 μm to 0.4 μm, as measured using a three dimensional surface structure analysis microscope ZYGO NEW VIEW 5000 (trade name, manufactured by ZYGO Corporation) under the following conditions; measurement area: 1 cm²; objective lens: 2.5 magnifications; and band path filter: from 0.02 mm to 0.5 mm.

Polyolefin Resin Layer

The substrate includes a resin layer (a polyolefin resin layer) containing a polyolefin resin (preferably as a main component thereof) on one or both sides of the base paper. In other words, the substrate includes the first polyolefin resin layer provided on the first surface of the base paper, and may further include the second polyolefin resin layer provided on the second surface of the base paper. Examples of the polyolefin resin used in the polyolefin resin layer include polyethylene and polypropylene. The polyethylene to be used may be a high density polyethylene (HDPE), low density polyethylene (LDPE), or linear low density polyethylene (L-LDPE). From the viewpoint of the stiffness of a substrate for photographic paper, it is preferable to use polypropylene, high density polyethylene (HDPE), or linear low density polyethylene (L-LDPE). The resin may be used alone, or a mixture of two or more thereof may be used.

Here, high density polyethylene and low density polyethylene are defined in JIS K6748: 1995, which is incorporated herein by reference. High density polyethylene is polyethylene having a density of 0.942 g/cm³ or higher, and low density polyethylene is polyethylene having a density of from 0.880 g/cm³ to 0.930 g/cm³. Linear low density polyethylene is polyethylene defined in JIS K6899-1: 2000, which is incorporated herein by reference.

Generally, a polyolefin resin layer is often formed using low density polyethylene. However, in order to improve thermal resistance of the substrate, it is preferable to use propylene, a blend of polypropylene and polyethylene, high density polyethylene, or a blend of high density polyethylene and low density polyethylene. Particularly, from the viewpoints of costs, laminate suitability, it is most preferable to use a blend of high density polyethylene and low density polyethylene.

For example, a blend of high density polyethylene and low density polyethylene at a blend ratio (high density polyethylene/low density polyethylene in terms of mass ratio) of from 1/9 to 9/1 is used. The blend ratio is preferably from 2/8 to 8/2, and more preferably from 3/7 to 7/3.

The molecular weight of polyethylene is not particularly limited. However, the high density polyethylene and the low density polyethylene each preferably have a melt index within a range of from 1.0 g/10 min to 40 g/10 min, and each preferably have extrusion suitability.

The method of forming the polyolefin resin layer on one or both sides of the base paper is not particularly limited, and may be suitably selected depending on the purpose. For example, the polyolefin resin layer may be formed by any of the following (i) to (iv): (i) dry-laminating, or adhering, a polyolefin film onto the base paper, (ii) coating a polyolefin resin on the base paper using an organic solvent, (iii) aqueous-coating a polyolefin resin on the base paper using a polyolefin emulsion, (iv) impregnating the base paper with a polyolefin emulsion, or (v) melt-coating a polyolefin resin on the base paper. From the points of productivity, it is preferred that the polyolefin resin layer is formed by melt-extrusion coating.

The thickness of the polyolefin resin layer is not particularly limited. However from the viewpoints of smoothness and water resistance, the thickness of the polyolefin resin layer is preferably from 1 μm to 50 μm, more preferably from 5 μm to 35 μm, and even more preferably from 10 μm to 20 μm. The thickness of the polyolefin resin layer may be determined by cutting the layer using a microtome (trade name: MICROTOME RM2165, manufactured by LEICA) to obtain a slice and measuring the thickness of the slice using an optical microscope (trade name, OPTICAL MICROSCOPE BX-60, manufactured by OLYMPUS CORPORATION).

The amount of polyolefin contained in the polyolefin resin layer is not particularly limited. However, from the viewpoints of smoothness and water resistance, the amount of polyolefin contained in the polyolefin resin layer is preferably from 5 g/m² to 30 g/m², more preferably from 10 g/m² to 25 g/m², and even more preferably from 15 g/m² to 20 g/m².

The polyolefin resin layer preferably contains a white pigment or a fluorescent whitening agent, if necessary, in addition to the polyolefin resin.

The fluorescent whitening agent is a compound that has absorption in the near ultraviolet region and emits fluorescence at an emission wavelength of from 400 nm to 500 nm. Known fluorescent whitening agent may be used without particular limitations. Preferable examples of the fluorescent whitening agent include the compounds described in “The Chemistry of Synthetic Dyes”, volume V, chapter 8, edited by K. VeenRataraman. Specific examples of fluorescent whitening agents include a stilbene compound, a coumalin compound, a biphenyl compound, a benzoxazoline compound, a naphthalimide compound, a pyrazoline compound, and a carbostyril compound. More specific examples include WHITE FULFAR PSN, PHR, HCS, PCS, and B (trade names, all manufactured by Sumitomo Chemical Co., Ltd.), and UVITEX-OB (trade name, manufactured by Ciba-Geigy Co., Ltd.).

Examples of the white pigment include titanium oxide, calcium carbonate, barium sulfate, and zinc oxide. Among these, titanium oxide is preferable from the point of shielding properties.

The content of the white pigment or the fluorescent whitening agent is preferably from 0.1 g/m² to 8 g/m², and more preferably from 0.5 g/m² to 5 g/m². When the content is lower than 0.1 g/m², light transmittance of the substrate is high. When the content exceeds 8 g/m², cracking of the surface of the substrate may occur, and handling properties such as adhesion resistance may deteriorate.

Layer Containing Pigment

It is preferred that the substrate further includes a pigment-containing layer (hereinafter, referred to as a “back coat layer” in some cases) on the polyolefin resin layer (second polyolefin resin layer) at one side of the substrate.

The pigment used in the back coat layer is not particularly limited, and known organic pigments and inorganic pigments may be used. The pigment may be used singly, or a mixture of two or more thereof may be used.

Examples of pigments include inorganic white pigments such as precipitated calcium carbonate, ground calcium carbonate, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, colloidal silica, colloidal alumina, pseudoboehmite, aluminum hydroxide, aluminum oxide (alumina), lithopone, zeolite, hydrated halloysite, magnesium carbonate, and magnesium hydroxide; and organic pigments such as styrene-based plastic pigments, acrylic plastic pigments, polyethylene, microcapsules, urea resins, and melamine resins. From the viewpoint of improving image density while maintaining transparency of the recording medium, a white pigment is preferable.

The back coat layer may further contain at least one additive such as an aqueous binder, an oxidation inhibitor, a surfactant, a defoaming agent, an anti-foaming agent, a pH adjuster, a curing agent, a coloring agent, a fluorescent whitening agent, an antiseptic agent, or a water-resistant additive. Examples of the aqueous binder include water-soluble polymers such as a copolymer of styrene/maleic acid salt, a copolymer of styrene/acrylic acid salt, polyvinyl alcohol, silanol-modified polyvinyl alcohol, starch, cationized starch, casein, gelatin, carboxymethyl cellulose, hydroxyethyl cellulose, and polyvinylpyrrolidone; and water-dispersible polymers such as a styrene-butadiene latex and an acrylic emulsion.

The method of forming the back coat layer on the polyolefin resin layer is not particularly limited, and may be suitably selected depending on the purposes. For example, the back coat layer may be formed by coating a dispersion liquid in which a pigment is dispersed in water, followed by drying.

In the present invention, the amount of the pigment contained in the back coat layer is preferably in a range of from 0.01 g/m² to 20 g/m², and more preferably from 0.02 g/m² to 10 g/m². When the amount of the pigment is 0.01 g/m² or more, blocking resistance is excellent. When the amount of the pigment is 20 g/m² or less, deterioration in brittleness is suppressed.

Further, the amount of the pigment contained in the back coat layer is preferably 10% by mass or more, more preferably 14% by mass or more, and even more preferably 18% by mass or more, with respect to the total solid content of the back coat layer.

Cooling-Separation Treatment

In the method of producing a recording medium of the present invention, a substrate including a polyolefin resin layer disposed on one or both sides of a base paper is subjected to a cooling-separation treatment by applying heat and pressure to a surface at a temperature of at least 80° C. and less than 140° C. using a heating and pressurizing unit in a cooling-separation belt-fixing smoother apparatus, cooling the surface to a temperature of 60° C. or lower, and then separating the surface from a belt member of the heating and pressurizing unit.

When the heating and pressurizing unit in the cooling-separation belt-fixing smoother apparatus is brought into contact with the substrate, the polyolefin resin layer is softened due to heating and deformed due to pressure. However, a substrate having excellent water resistance, excellent surface smoothness, favorable surface gloss, and reduced surface defects can be provided when the following procedure is taken:

heat and pressure is applied under a temperature condition in which a blister (blister in the resin layer due to expansion caused by evaporation of moisture content contained in the base paper) does not occur, and then

the substrate is cooled to a temperature condition that allows the polyolefin resin layer to solidify, and then

the substrate is separated from the belt member.

The substrate is heated at a temperature of at least 80° C. and lower than 140° C. by contacting with the heating and pressurizing unit. When the heating temperature is lower than 80° C., the effects in substrate performance improvement achieved by the cooling-separation treatment are insufficient. When the heating temperature is 140° C. or higher, blisters tend to occur.

The heating temperature is preferably from 100° C. to 130° C. from the viewpoints of further improving the surface gloss and image clarity and further reducing surface defects of a recording medium that is prepared using the substrate.

Here, the “heating temperature” means the temperature of the heating and pressurizing unit, and is a value obtained by measurement using a non-contact thermometer.

A pressure is applied when the substrate is contacted with the heating and pressurizing unit. The method of applying pressure is not particularly limited. It is preferable to apply a nip pressure. The nip pressure is preferably from 1 kgf/cm² to 100 kgf/cm², and more preferably from 5 kgf/cm² to 30 kgf/cm², from the point of efficiently producing a substrate having excellent water resistance, excellent surface smoothness, favorable surface gloss, and reduced surface defects.

The substrate is heated and pressurized using the heating and pressurizing unit, and thereafter is cooled. The cooling temperature is 60° C. or lower, at which sufficient solidification of the polyolefin resin layer occurs. The cooling temperature is preferably from 25° C. to 60° C. from the viewpoints of productivity and economical efficiency.

Here, the “cooling temperature” means the temperature of the belt member, and is a value obtained by measurement using a non-contact thermometer.

The method of cooling the substrate is not particularly limited. The cooling is performed preferably by using a cooling device that performs a treatment subsequent to the application of heat and pressure by the heating and pressurizing unit, from the viewpoint of productivity.

The conveyance speed of the belt of the belt-fixing smoother apparatus when applying heat and pressure to the substrate or when cooling the substrate is not particularly limited. However, the conveyance speed of the belt may be set so as to achieve a desired target temperature of the polyolefin resin layer, in consideration of, for example, the temperature of the heating and pressurizing unit, the method of applying pressure, or the temperature of the cooling member in the cooling device.

Heating and Pressurizing Unit in Cooling-Separation Belt-Fixing Smoother Apparatus

There is no particular limitation on the heating and pressurizing unit in the cooling-separation belt-fixing smoother apparatus, which is used for the cooling-separation treatment according to the present invention. For example, the heating and pressurizing unit to be used may be a combination of a heating roller, a pressurization roller, and an endless belt member.

It is preferred that the belt member of the heating and pressurizing unit includes a thin film which includes at least one selected from the group consisting of a silicone rubber, a fluoro rubber, a silicone resin, and a fluorocarbon resin, and which forms a surface of the belt member. In particular, it is preferable that the belt member includes a fluorocarbon siloxane rubber layer having a uniform thickness that forms a surface of the belt member. It is also preferable that the belt member includes a silicone rubber layer having a uniform thickness and a fluorocarbon siloxane rubber layer which is further provided on the surface of the silicone rubber layer and which forms a surface of the belt member.

The fluorocarbon siloxane rubber preferably has at least one of a perfluoroalkyl ether group or a perfluoroalkyl group, in a main chain.

The fluorocarbon siloxane rubber is preferably a cured product of a fluorocarbon siloxane rubber composition including the following components (A) to (D): (A) a fluorocarbon polymer containing, as a main component, a fluorocarbon siloxane represented by the following Formula (1) and having an aliphatic unsaturated group; (B) an organopolysiloxane and/or a fluorocarbon siloxane, each of which has two or more ≡SiH groups in a molecule thereof, wherein the content of the SiH groups is from one to four times (by mole) as high as the content of aliphatic unsaturated groups in the fluorocarbon siloxane rubber composition; (C) a filler; and (D) an effective amount of a catalyst.

The fluorocarbon polymer as the component (A) contains, as a main component, a fluorocarbon siloxane having a repeating unit represented by the following Formula (1). Further, the fluorocarbon polymer of the component (A) has an aliphatic unsaturated group.

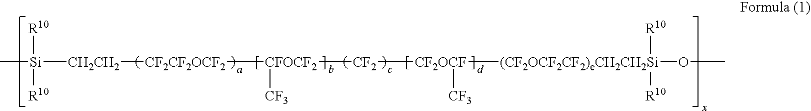

In Formula (1), R¹⁰ represents an unsubstituted or substituted monovalent hydrocarbon group having preferably from 1 to 8 carbon atoms. R¹⁰ represents more preferably an alkyl group having from 1 to 8 carbon atoms or an alkenyl group having from 2 or 3 carbon atoms, and particularly preferably a methyl group. In Formula (1), a and e each represent 0 or 1; b and d each represent an integer of from 1 to 4; c represents an integer of from 0 to 8; x represents an integer of 1 or greater, and preferably an integer of from 10 to 30.

Specific examples of the Component (A) include a polymer represented by the following Formula (2).

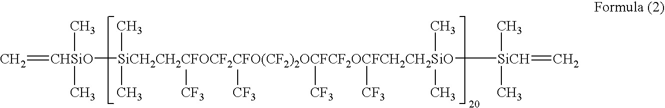

In the component (B), examples of the organopolysiloxane having ≡SiH groups include an organohydrogenpolysiloxane in which the number of hydrogen atoms bonded to silicon atoms in a molecule thereof is at least two.

In the fluorocarbon siloxane rubber composition used in the present invention, since the fluorocarbon polymer as the component (A) has an aliphatic unsaturated group, the organohydrogenpolysiloxane described above may be used as a curing agent. That is, in this case, a cured product is formed by an addition reaction between an aliphatic unsaturated group in the fluorocarbon siloxane and a hydrogen atom bonded to a silicon atom in the organohydrogenpolysiloxane.

The organohydrogenpolysiloxane may be selected from various organohydrogenpolysiloxanes which are used for addition-curable silicone rubber compositions.

Generally, the organohydrogenpolysiloxane described above is preferably added such that the number of ≡SiH groups thereof is at least one, preferably from one to five, per one aliphatic unsaturated hydrocarbon group of the fluorocarbon siloxane of Component (A).

Further, the fluorocarbon siloxane having ≡SiH groups preferably include a unit represented by Formula (1) described above or a unit that is the same as a unit represented by Formula (1) except that R¹⁰ represents a dialkylhydrogensiloxy group, and a terminal of the fluorocarbon siloxane is preferably an SiH group such as a dialkylhydrogensiloxy group or a silyl group. Examples of the fluorocarbon siloxane include a compound represented by the following Formula (3).

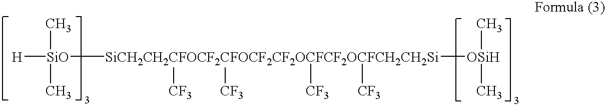

The filler as the component (C) may be selected from various kinds of fillers used in general silicone rubber compositions. Examples of the filler include reinforcing fillers such as fumed silica, precipitated silica, carbon powder, titanium dioxide, aluminum oxide, quartz powder, talc, sericite, and bentonite; and fibrous fillers such as asbestos, glass fibers, and organic fibers.

The catalyst as the component (D) may be a catalyst for addition reaction known in the art, specific examples thereof include chloroplatinic acid; alcohol-modified chloroplatinic acid; complex of chloroplatinic acid and olefin; platinum black or palladium retained on a carrier such as alumina, silica, or carbon; elements belonging to Group VIII of the Periodic Table or compounds thereof such as complexes of rhodium and olefin, chlorotris(triphenylphosphine)rhodium (Wilkinson's catalyst), and rhodium(III) acetylacetonate. A complex as the catalyst, such as those described above, is preferably dissolved in a solvent, such as an alcohol solvent, an ether solvent, or a hydrocarbon solvent, when used.

Various agents may be mixed into the fluorocarbon siloxane rubber composition used in the present invention, within a range at which improvement in solvent resistance is not impaired. For example, one or more of the following agents may be added as necessary: a dispersant such as diphenylsilanediol, dimethylpolysiloxane which has a low polymerization degree and of which molecular chain terminal is blocked by a hydroxyl group, or hexamethyl disilazane; a thermal resistance-enhancing agent such as ferrous oxide, ferric oxide, cerium oxide, or iron octylate; or a coloring agent such as a pigment.

The belt member may be obtained by covering the surface of a belt, which may be made of a heat-resistant resin or a metal, with the fluorocarbon siloxane rubber composition, and then thermally curing the rubber composition. Here, the fluorocarbon siloxane rubber composition may be diluted with a solvent such as m-xylene hexafluoride or benzotrifluoride, as necessary, to prepare a coating liquid, and then the coating liquid may be coated according to a general coating method such as spray coating, dip coating, or knife coating. The temperature and time for the thermal curing may be suitably selected. In general, the temperature and time for the thermal curing may be selected from a temperature range of from 100° C. to 500° C. and a time range of from 5 seconds to 5 hours, in consideration of the kind and production method of the belt.

The thickness of the fluorocarbon siloxane rubber layer that forms a surface of the belt member is not particularly limited. The thickness is usually from 20 μm to 500 μm, and particularly preferably from 40 μm to 200 μm.

The surface roughness (arithmetic average roughness (Ra)) of the belt member is preferably 20 μm or less, more preferably 5 μm or less, and even more preferably 1 μm or less, from the point of efficiently manufacturing a substrate having excellent surface smoothness and favorable surface gloss. The arithmetic average roughness may be measured based on JIS B0601, B0651, and B0652, which are incorporated herein by reference. JIS B0601 is equivalent to ISO 4287:1997, and JISB0651 is equivalent to ISO 3274:1996.

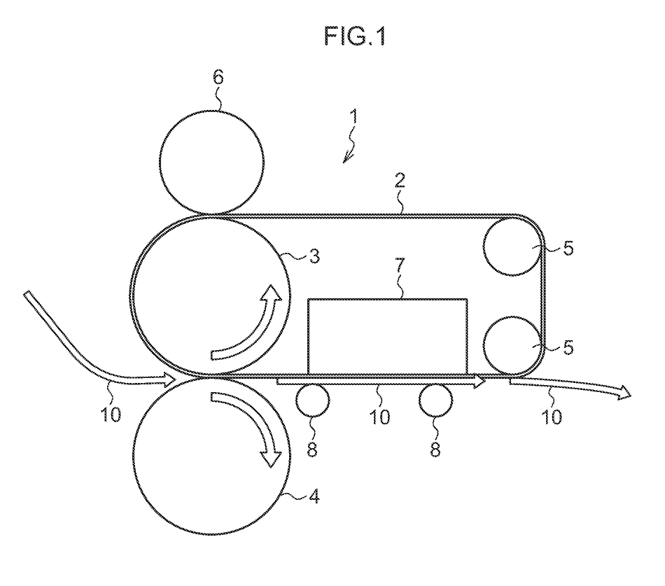

The belt member is not particularly limited. An endless belt in a cooling-separation belt-fixing smoother apparatus is preferable. The cooling-separation belt-fixing smoother apparatus is not particularly limited, and may be suitably selected depending on the purposes. For example, an embodiment as shown in FIG. 1 is preferable, in which a cooling device for the belt member is provided at a downstream-side portion of the fixation unit, and allows a post treatment for cooling separation whereby the temperature is adjusted to a low temperature when separating a substrate.

In the above cooling device, cooling may be performed so as to cool the polyolefin resin layer to a temperature of 60° C. or lower, thereby allowing sufficient solidification of the polyolefin resin layer.

The belt member is particularly preferably an endless belt due to its capability of efficient continuous processing of the substrate.

The surface roughness of the substrate (arithmetic average roughness (SRa)) that has been subjected to the cooling-separation treatment is preferably 20 μm or less, and more preferably 15 μm or less. The arithmetic average roughness is measured using NEW VIEW 5022 (trade name, manufactured by ZYGO Corporation) under the following conditions:

cut off value: from 0.05 mm to 0.06 mm

measurement length: 1 cm in X direction and 1 cm in Y direction

objective lens: 2.5 magnifications.

Corona Discharge Treatment

In the method of producing a recording medium of the present invention, it is preferred that the surface at a side of the substrate that has been subjected to the cooling-separation treatment is further subjected to a corona discharge treatment. The corona discharge treatment improves adhesion between the substrate and an image recording layer that is formed on the substrate after the corona discharge treatment.

In the present invention, from the viewpoint of providing sufficient adhesion of the image recording layer to the substrate, the corona discharge treatment is preferably performed under an atmosphere containing carbon dioxide gas in an amount of 20% by volume or more, and more preferably in an amount of from 40% by volume to 100% by volume. Gases other than carbon oxide gas may be further contained in the atmosphere of the corona discharge treatment as far as the process efficiency of carbon dioxide corona discharging is not impaired. Examples of other gases include air, nitrogen gas, argon gas, and oxygen gas.

In the present invention, a basic method for the corona discharge treatment may be a known processing method such as a spark gap system, a vacuum tube system, or a solid state system. Specifics thereof may be as follows.

In general, corona discharge is formed between a discharge electrode and a rotatable roll-shaped electrode which supports a substance to be processed and which is disposed to face the discharge electrode. The shape of the discharge electrode may be any of a rod shape, a board shape, or a knife shape. The material of the discharge electrode is preferably an electrically conductive material (for example, stainless steel, aluminum, or copper). The roll-shaped electrode is preferably an electrode in which a surface of a conductor is coated with a dielectric substance. The dielectric substance may be suitably selected from rubber, glass, ceramics, or the like. Furthermore, two or more discharge electrodes may be provided with respect to one roll-shaped electrode.

The distance between the discharge electrode and the roll-shaped electrode is preferably from 0.5 mm to 10 mm. The corona processing amount (discharge amount) is preferably from 30 W·min/m² to 350 W·min/m². The distance and the corona processing amount may be suitably selected from the above ranges, respectively.

For corona discharge, the introduction amount (blow amount) of the gas may be determined so that the amount of gas is sufficient for substituting the processing atmosphere. From the economical point of view and from the point of improvement in adhesive property, the introduction amount per unit width is preferably from 20 L/min·m to 300 L/min·m, and more preferably from 40 L/min·m to 250 L/min·m.

The gas to be introduced (blown) at the time of electric discharge and the substance to be processed may be heated in advance to corona discharge.

The processing device to be used for corona discharge treatment in the present invention is not particularly limited as far as corona discharge treatment can be performed on the substance to be processed in the presence of a desired carbon dioxide gas. From the viewpoint of saving the amount of gas to be used and the viewpoint of substitution efficiency of the atmosphere, a device having an ejection nozzle and capable of discharging the gas from the ejection nozzle is preferable, and a device having a combination of an ejection nozzle and a cover that shields the outside air is more preferable. Here, the shape of the ejection nozzle is preferably a shape that allows the atmosphere to be substituted uniformly with respect to the width direction of the substrate. In particular, a slit-shaped ejection nozzle is preferable.

Image Recording Layer

In the method of producing a recording medium of the present invention, an image recording layer is formed on a surface at a side of the substrate which has been subjected to the cooling-separation treatment.

The image recording layer may be formed by applying, onto the substrate, a liquid including a composition for an image recording layer (hereinafter, referred to as an “image recording layer forming liquid” in some cases), and then drying the coating layer formed by the application of the image recording layer forming liquid. The application of the image recording layer forming liquid may be performed according to a known coating method using, for example, an extrusion die coater, an air doctor coater, a blade coater, a rod coater, a knife coater, a squeeze coater, a reverse roll coater, or a bar coater.

The image recording layer is not particularly limited as far as the layer is capable of image formation. The image recording layer is preferably an ink receiving layer including inorganic fine particles and a water-soluble resin, with a view to achieving the effects in improvements in surface gloss and image clarity and in reduction of surface defects. The ink receiving layer may be formed by applying, onto the substrate, a liquid containing at least inorganic fine particles and a water-soluble resin (hereinafter, referred to as an “ink receiving layer forming liquid” in some cases), and then drying the formed coating layer (hereinafter, also referred to as the “coating film”).

In the above case, it is preferred that a basic solution having a pH of 7.1 or higher is further prepared, and that the ink receiving layer forming liquid and the basic solution having a pH of 7.1 or higher are applied onto the substrate. In this process, the ink receiving layer forming liquid and the basic solution having a pH of 7.1 or higher may be mixed by in-line blending, and applied.

Another method of applying the ink receiving layer forming liquid and the basic solution having a pH of 7.1 or higher includes applying the basic solution having a pH of 7.1 or higher either at the same time as the application of the ink receiving layer forming liquid or during drying of the coating layer formed by the application of the ink receiving layer forming liquid but before the coating layer shows falling-rate drying. In other words, the ink receiving layer may favorably be formed by introducing the basic solution having a pH of 7.1 or higher, during the period in which the coating layer shows a constant-rate drying after the application of the ink receiving layer forming liquid.

The basic solution having a pH of 7.1 or higher may include a crosslinking agent, if necessary. The basic solution having a pH of 7.1 or higher may accelerate curing of the ink receiving layer when the basic solution having a pH of 7.1 or higher is used as an alkali solution. The pH of the basic solution is preferably 7.5 or higher, and particularly preferably 7.9 or higher. When the pH is too close to the acidic side, the crosslinking reaction of the water-soluble resin caused by the crosslinking agent does not proceed sufficiently, as a result of which bronzing may occur and/or defects such as cracking may occur in the ink receiving layer.

The basic solution having a pH of 7.1 or higher may be prepared, for example, by adding a metal compound (for example, in an amount of from 1% to 5%), a basic compound (for example, in an amount of from 1% to 5%), and, if necessary, p-toluenesulfonic acid (for example, in an amount of from 0.5% to 3%) to ion-exchange water, and thoroughly stirring the resulting mixture. Here, “%” above for each compound means % by mass of the solid content.

Here, the expression “before the coating layer shows falling-rate drying” usually refers to a period of several minutes from immediately after the application of the coating liquid, and, in this period, the applied coating layer shows the phenomenon of “constant-rate drying” whereby the solvent (dispersion medium) content in the coating layer decreases in proportion to a lapse of time. With respect to the period during which the constant-rate drying is observed, Kagaku Kogaku Binran (Handbook of Chemical Technology), pages 707-712, MARUZEN Co., Ltd. (Oct. 25, 1980) may be referenced, for example.

As described above, after the application of an ink receiving layer forming liquid, the coating layer is dried until the coating layer shows a falling-rate drying. The drying may be performed generally at from 40° C. to 180° C. for from 0.5 minutes to 10 minutes (preferably from 0.5 minutes to 5 minutes). Although the drying time naturally varies with the coating amount, the range specified above is usually appropriate.

Drying of the coating film is preferably performed under conditions in which, at some point during the drying, the surface temperature of the coating film is made lower than the liquid temperature of the ink receiving layer forming liquid at the time of the application. Specifically, the drying process of the coating film preferably includes a drying stage at which the surface temperature becomes lower than the liquid temperature of the ink receiving layer forming liquid at the time of the application. The surface temperature of the coating film may be made lower than the above liquid temperature at an earlier stage of drying, or the surface temperature of the coating film may be made lower than the above liquid temperature after a certain period of time has elapsed since the initiation of drying, or the surface temperature of the coating film may be made lower than the above liquid temperature at a late stage of drying. In particular, the drying stage in which the surface temperature of the coating film is made lower than the liquid temperature is preferably an early stage of drying, particularly preferably immediately after the initiation of drying, from the viewpoint of uniformity of the coated surface and the viewpoint of void capacity. When performing drying such that the surface temperature of the coating film is made lower than the liquid temperature at an earlier stage of drying (particularly, immediately after the initiation of drying), drying irregularities may be prevented and glossiness may be enhanced, even when the ink receiving layer forming liquid used for the application has a low viscosity.

The surface temperature of the coating film is preferably from 0° C. to 30° C., and more preferably from 5° C. to 20° C., though it depends on the composition of the ink receiving layer forming liquid and the liquid temperature of the ink receiving layer forming liquid at the time of the application. When setting the surface temperature of the coating film to 0° C. or higher, an excessive increase in viscosity of the applied ink receiving layer forming liquid is prevented, formation of irregularities on the surface of the coating film is inhibited, and a sense of glossiness is obtained. The surface temperature of the coating film as described herein refers to the temperature of the surface of the coating film during the drying. The surface temperature of the coating film may be measured using a radiation thermometer.

The drying temperature is preferably from 60° C. to 200° C., and more preferably from 70° C. to 150° C., though it depends on the thermal resistance of the substrate. A drying temperature within this range allows sufficient drying of the ink receiving layer, improves ink absorbency when a heat treatment is performed under conditions in which the substrate is not deteriorated, and improves the water resistance of the ink receiving layer.

Since the ink receiving layer should have an absorption capacity that allows absorption of all ink droplets, the thickness of the ink receiving layer prepared by drying the ink receiving layer forming liquid on the substrate may be determined in relation to the porosity of the ink receiving layer. For example, when the amount of ink is 8 mL/mm² and the porosity is 60%, the thickness of the ink receiving layer should be about 15 μm or more. From this viewpoint, the thickness of the ink receiving layer is preferably from 10 μm to 50 μm.

The pore diameter of the ink receiving layer is preferably from 0.005 μm to 0.030 μm, and more preferably from 0.01 μm to 0.025 μm, in terms of median diameter.

The porosity and the pore median diameter may be measured using a mercury porosimeter (trade name: PORESIZER 9320-PC2, manufactured by Shimadzu Corporation).

In the invention, the recording medium having the ink receiving layer containing inorganic fine particles and a water-soluble resin is suitable for use in inkjet recording, which involve recording by ejecting ink droplets according to an inkjet method, due to enhanced effects thereof in improvement of glossiness and image clarity and in reduction of surface defects.

Inorganic Fine Particles

Examples of the inorganic fine particles include silica fine particles, colloidal silica, titanium dioxide fine particles, barium sulfate fine particles, calcium silicate fine particles, zeolite fine particles, kaolinite fine particles, halloysite fine particles, mica fine particles, talc fine particles, calcium carbonate fine particles, magnesium carbonate fine particles, calcium sulfate fine particles, boehmite fine particles, and pseudoboehmite fine particles. Among these, silica fine particles are preferable.

Silica fine particles have high efficiency with respect to absorption and retaining of ink, as a result of their particularly high specific surface area. Further, since the silica fine particles have a low refractive index, a transparent ink receiving layer can be provided when the silica fine particles are dispersed to an appropriate microparticle diameter, and high color density and favorable color exhibiting properties can be provided. The transparency of the ink receiving layer is important from the viewpoints of obtaining high color density and favorable color exhibiting properties and glossiness.

The average primary particle diameter of the inorganic fine particles is preferably 20 nm or less, more preferably 15 nm or less, and particularly preferably 10 nm or less. When the average primary particle diameter is 20 nm or less, ink absorption characteristics is effectively improved and, at the same time, glossiness of the surface of the ink receiving layer is enhanced.

The specific surface area of the inorganic fine particles as determined by the BET method is preferably 200 m²/g or higher, more preferably 250 m²/g or higher, and particularly preferably 380 m²/g or higher. When the specific surface area of the inorganic fine particles is 200 m²/g or higher, the ink receiving layer has high transparency and it is possible to obtain high image density.

The BET method in the present invention is a method of measuring a surface area of powder using a vapor-phase adsorption method, and is a method of determining the total surface area per 1 g of a specimen—a specific surface area—from an adsorption isotherm. Usually, as a gas to be adsorbed, nitrogen gas is often used, and a method of determining the adsorption amount from a change in pressure or volume of the adsorbed gas is most widely used. An equation proposed by Brunauer, Emmett, and Teller, which is called a BET equation, is the most famous equation representing an isotherm of multimolecular adsorption. The BET equation is widely used for determining surface area. An adsorption amount is determined on the basis of the BET equation, and the resulting adsorption amount is multiplied by an area on the surface occupied by one adsorbed molecule, whereby the surface area is determined.

Silica fine particles, in particular, have silanol groups on surfaces thereof. The particles easily adhere to each other through hydrogen bonding of the silanol groups, and particles are adhered to one another also via an interaction between the water-soluble resin and the silanol groups. Hence, when the average primary particle diameter of silica fine particles is 20 nm or less as described above, the porosity of the ink receiving layer is high, a structure with high transparency is formed, and ink absorption characteristics are effectively improved.

In general, the silica fine particles are roughly classified into wet process silica particles and dry process (vapor-phase process) silica particles according to the production method thereof. In the wet process, a method of producing hydrous silica by forming active silica by acid decomposition of a silicate, polymerizing the active silica to a certain degree, and allowing the resultant polymerized product to aggregate and precipitate, is widely used. In the vapor-phase process, a method of producing anhydrous silica by high-temperature vapor-phase hydrolysis of a silicon halide (flame hydrolysis) or a method in which silica sand and coke are subjected to heat reduction and evaporation by arc in an electronic furnace and the resultant product is oxidized by air (arc process), are widely used. The “vapor-phase process silica” as used herein refers to anhydrous silica fine particles obtained by the vapor-phase processes.

The vapor-phase process silica differs from the hydrous silica in density of silanol groups on the surface thereof, the presence or absence of pores, and the like, and exhibits different properties from those of the hydrous silica. The vapor-phase process silica is suitable for forming three-dimensional structures having high porosity, though the reason is not clear. It may be because, whilst the hydrous silica fine particles tend to closely aggregate (i.e., form aggregates) owing to high silanol densities of from 5 groups/nm² to 8 groups/nm² on the fine particle surface, the vapor-phase process silica particles form loose aggregates (i.e., flocculates) owing to low silanol densities of from 2 groups/nm² to 3 groups/nm² on the fine particle surface, which results in formation of a highly-porous structure.

In the present invention, vapor-phase process silica fine particles (anhydrous silica) obtained by the dry process described above are preferable, and silica fine particles having the silanol densities of from 2 groups/nm² to 3 groups/nm² on the fine particle surface are more preferable. The inorganic fine particles most preferably used in the present invention are vapor-phase process silica having a specific surface area of 200 m²/g or more as determined by the BET method.

In the present invention, the amount of the inorganic fine particles contained in the image recording layer is not particularly limited. However, from the points of allowing formation of a favorable porous structure and providing a recording medium having sufficient ink absorbency, the amount of the inorganic fine particles contained in the image recording layer is preferably from 5 g/m² to 20 g/m², more preferably from 8 g/m² to 18 g/m², and even more preferably from 10 g/m² to 15 g/m².

Here, the expression “the amount of the inorganic fine particles contained in the image recording layer” as used herein refers to a content calculated on the basis of the amount of components other than water in the composition constituting the image recording layer.

Water-Soluble Resin

Examples of water-soluble resins include polyvinyl alcohol resins having a hydroxyl group as a hydrophilic group (for example, polyvinyl alcohol (PVA), acetoacetyl-modified polyvinyl alcohol, cation-modified polyvinyl alcohol, anion-modified polyvinyl alcohol, silanol-modified polyvinyl alcohol, and polyvinyl acetal), cellulose resins (for example, methyl cellulose (MC), ethyl cellulose (EC), hydroxyethyl cellulose (HEC), carboxymethyl cellulose (CMC), hydroxypropyl cellulose (HPC), hydroxyethyl methyl cellulose, and hydroxypropyl methyl cellulose), chitins, chitosans, starches, resins having an ether bond (for example, polyethylene oxide (PEO), polypropylene oxide (PPO), and polyvinyl ether (PVE)), and resins having a carbamoyl group (for example, polyacrylamide (PAAM), polyvinyl pyrrolidone (PVP), and polyacrylic acid hydrazide).

Further, examples include polyacrylic acid, maleic acid resins, alginic acid, and gelatins, each of which has a carboxyl group and/or a salt thereof as a dissociative group.

Among the above resins, polyvinyl alcohol resins are particularly preferable. Examples of polyvinyl alcohol resins include those described in Japanese Patent Publication (JP-B) Nos. 4-52786, 5-67432 and 7-29479, Japanese Patent No. 2537827, JP-B No. 7-57553, Japanese Patent Nos. 2502998 and 3053231, JP-A No. 63-176173, Japanese Patent No. 2604367, JP-A Nos. 7-276787, 9-207425, 11-58941, 2000-135858, 2001-205924, 2001-287444, 62-278080 and 9-39373, Japanese Patent No. 2750433, JP-A Nos. 2000-158801, 2001-213045, 2001-328345, 8-324105 and 11-348417.

Further, examples of water-soluble resins other than polyvinyl alcohol resins include the compounds described in paragraphs [0011] to [0014] of JP-A No. 11-165461.

The water-soluble resin may be used singly, or two or more there may be used in combination.

The content of the water-soluble resin used in the present invention is preferably from 9% by mass to 40% by mass, and more preferably from 12% by mass to 33% by mass, with respect to the total solid mass of the ink receiving layer.

The inorganic fine particle and the water-soluble resin are main components of the ink receiving layer. The inorganic fine particle may be composed of a single material or may be a mixture of plural materials. The water-soluble resin may be composed of a single material or may be a mixture of plural materials.

From the viewpoint of improving image density while maintaining transparency, the kind of the water-soluble resin which is used in combination with the inorganic fine particles is important. A polyvinyl alcohol resin is preferable as the water-soluble resin. In particular, a polyvinyl alcohol resin having a saponification degree of from 70% to 100% is more preferable, and a polyvinyl alcohol resin having a saponification degree of from 80% to 99.5% is particularly preferable.

Further, the polyvinyl alcohol resin may be used in combination with a water-soluble resin other than the polyvinyl alcohol resin. When used in combination, the content of the polyvinyl alcohol resin in the total of water-soluble resins is preferably 50% by mass or higher, and more preferably 70% by mass or higher.

Content Ratio of Inorganic Fine Particles to Water-Soluble Resin

The content ratio by mass (PB ratio (x/y)) of the inorganic fine particles (x) to the water-soluble resin (y) has a large influence on the film structure and the film strength of the ink receiving layer. In other words, a higher content ratio by mass (PB ratio) provides a higher porosity, a higher pore volume, and a larger surface area (per unit mass) while density and strength tend to decrease.

The content ratio (PB ratio (x/y)) in the ink receiving layer of the present invention is preferably in a range of from 1.5 to 10 from the viewpoints of preventing a decrease in film strength and the cracks while drying, which are caused by excessively high PB ratios, and avoiding a reduction in ink absorbency that results from decrease in porosity due to an increased tendency for pores to be clogged by the resins, which is caused by excessively low PB ratios.

When passing through a conveyance system of an image recording apparatus, the recording medium may sometimes receive stress. Therefore, the ink receiving layer is required to have adequate film strength. Moreover, the adequate film strength of the ink receiving layer is required also from the viewpoint of preventing cracking, exfoliating, and the like of the ink receiving layer when the recording medium is cut into sheets. In view of the above, the content mass ratio (x/y) is preferably 5 or lower, and, from the viewpoint of providing ability to rapidly absorb ink when the recording medium is used in an inkjet printer, the content mass ratio (x/y) is more preferably 2 or higher.

For example, when a solution is prepared by completely dispersing vapor-phase process silica having an average primary particle diameter of 20 nm or less (x) and a water-soluble resin (y) in an aqueous solution at a content mass ratio (x/y) of from 2 to 5, and the resultant solution is applied on the substrate, and then the formed coating layer is dried, a three-dimensional network structure having secondary particles of the silica fine particles as the network chains is formed. As a result, a light-transmitting porous film having an average pore diameter of 30 nm or less, a porosity of from 50% to 80%, a specific pore volume of 0.5 mL/g or more, and a specific surface area of 100 m²/g or higher can be easily formed.

### Method of Preparing Ink Receiving Layer Forming Liquid

The ink receiving layer forming liquid may be formed, for example, using the following methods.

When vapor-phase process silica is used as the inorganic fine particles, vapor-phase process silica and a dispersant are added into water (for example, the content of the vapor-phase silica in water is from 10% by mass to 20% by mass) and the resultant mixture is dispersed using a head-on-collision high pressure homogenizer (for example, “ULTIMIZER” (trade name), manufactured by Sugino Machine Limited) under a high pressure condition of, for example, 120 MPa (preferably, from 100 MPa to 200 MPa). Subsequently, a boron compound, an aqueous solution of PVA (for example, in an amount such that the mass of PVA is about one third of the mass of the vapor-phase process silica), and additional components are added thereto, and the resulting mixture is stirred, whereby an ink receiving layer forming liquid is prepared. The resulting ink receiving layer forming liquid is in a homogeneous sol state. When coating this ink receiving layer forming liquid onto a substrate, a porous ink receiving layer having a three-dimensional network structure can be formed.

After mixing the above vapor-phase process silica and the dispersant with water, the resulting mixture liquid may be dispersed using a disperser so as to decrease the particle size, as a result of which a water dispersion liquid containing silica fine particles having an average particle diameter of from 50 nm to 300 nm can be obtained. Examples of the disperser to be used for obtaining the water dispersion liquid include various kinds of known dispersers such as a high speed rotating disperser, a medium stirring disperser (for example, a ball mill or a sand mill), an ultrasonic disperser, a colloid mill disperser and a high pressure disperser. In order to efficiently disperse particles forming a lump, a stirring disperser, a colloid mill disperser and a high pressure disperser are preferable, and particularly, a head-on-collision high pressure disperser and an orifice-passing high pressure disperser are preferable.

Solvents used in the preparation may be selected from water, an organic solvent, or a mixed solvent thereof. Examples of organic solvents which can be used for the coating include alcohols such as methanol, ethanol, n-propanol, i-propanol, or methoxy propanol, ketones such as acetone or methyl ethyl ketone, tetrahydrofuran, acetonitrile, ethyl acetate, and toluene.

The dispersant may be a cationic polymer. Examples of the cationic polymer include organic mordants, polymers for coloring, and polyimines. Using a silane coupling agent as the dispersant is also preferable.

The amount of the dispersant to be added is preferably from 0.1% by mass to 30% by mass, and more preferably from 1% by mass to 10% by mass, with respect to the fine particles.

Additional Components

In addition to the above components, the image recording layer of the invention may include other known additives, as necessary, such as crosslinking agents, acids, ultraviolet absorbers, antioxidants, fluorescent whitening agents, monomers, polymerization initiators, polymerization inhibitors, bleed inhibitors, antiseptics, viscosity stabilizers, defoaming agents, surfactants, antistatic agents, mat agents, curling inhibitors, and water-resistant additives.

As a crosslinking agent for crosslinking the water-soluble resin, especially for crosslinking the polyvinyl alcohol, a boron compound is preferable. Examples thereof include borax, boric acid, borates (such as orthoborate, InBO₃, ScBO₃, YBO₃, LaBO₃, Mg₃(BO₃)₂ and CO₃(BO₃)₂), diborates (such as Mg₂B₂O₅ and CO₂B₂O₅), metaborates (such as LiBO₂, Ca(BO₂)₂, NaBO₂, and KBO₂), tetraborates (such as Na₂B₄O₇.10H₂O), pentaborates (such as KB₅O₈.4H₂O and CsB₅O₅) and hexaborates (such as Ca₂B₆O₁₁.7H₂O). Among these, from the viewpoint of rapidness of crosslinking reaction, borax, boric acid, and borates are preferable, and boric acid is particularly preferable.

Examples of a crosslinking agent for crosslinking the water-soluble resin include, in addition to the boron compounds, those described below. Examples of the crosslinking agent for crosslinking the water-soluble resin include: aldehyde compounds, such as formaldehyde, glyoxal and gultaraldehyde; ketone compounds, such as diacetyl and cyclopentanedione; active halogen compounds, such as bis(2-chloroethylurea)-2-hydroxy-4,6-dichloro-1,3,5-triazine and sodium salts of 2,4-dichloro-6-s-triazine; active vinyl compounds, such as divinylsulfonic acid, 1,3-bis(vinylsulfonyl)-2-propanol, N,N′-ethylenebis(vinylsulfonylacetamide) and 1,3,5-triacryloyl-hexahydro-s-triazine; N-methylol compounds, such as dimethylolurea and methyloldimethylhydantoin; melamine resins, such as methylolmelamine and alkylated methylolmelamine; epoxy resins; isocyanate compounds, such as 1,6-hexamethylene diisocyanate; the aziridine compounds described in U.S. Pat. Nos. 3,017,280 and 2,983,611; the carboxylmide compounds described in U.S. Pat. No. 3,100,704; epoxy compounds, such as glycerol triglycidyl ether; ethyleneimino compounds, such as 1,6-hexamethylene-N,N′-bisethyleneurea; halogenated carboxyaldehyde compounds, such as mucochloric acid and mucophenoxychloric acid; dioxane compounds, such as 2,3-dihydroxydioxane; metal-containing compounds, such as titanium lactate, aluminum sulfate, chrome alum, potassium alum, zirconyl acetate, and chromium acetate; polyamine compounds, such as tetraethylenepentamine; hydrazide compounds, such as adipic acid dihydrazide; low-molecular compounds each having at least two oxazoline groups; and polymers each having at least two oxazoline groups.

The crosslinking agent may be used singly, or two or more thereof may be used in combination. The amount of the crosslinking agent to be used is preferably from 1% by mass to 50% by mass, and more preferably from 5% by mass to 40% by mass with respect to the water-soluble resin.

The image recording layer according to the present invention may contain an acid. When adding an acid, the surface pH of the image recording layer is adjusted to be in a range of from 3 to 8, and preferably from 5 to 7.5. When adjusting the surface pH as described above, resistance to yellowing of the white background area is improved, which is preferable. Measurement of the surface pH is performed according to the “A method” (coating method) in the surface pH measurement methods defined by Japan Technical Association of the Pulp and Paper Industry (J. TAPPI). For example, the measurement may be performed using a pH indicator set for surface of paper, “TYPE MPC” (trade name, manufactured by Kyoritsu Chemical-Check Lab., Corporation), which corresponds to the above A method.

Specific examples of the acid include formic acid, acetic acid, glycolic acid, oxalic acid, propionic acid, malonic acid, succinic acid, adipic acid, maleic acid, malic acid, tartaric acid, citric acid, benzoic acid, phthalic acid, isophthalic acid, glutaric acid, gluconic acid, lactic acid, aspartic acid, glutamic acid, salicylic acid, metal salts of salicylic acid (salt of Zn, Al, Ca, Mg, or the like), methanesulfonic acid, itaconic acid, benzenesulfonic acid, toluenesulfonic acid, trifluoromethanesulfonic acid, styrenesulfonic acid, trifluoroacetic acid, barbituric acid, acrylic acid, methacrylic acid, cinnamic acid, 4-hydroxybenzoic acid, aminobenzoic acid, naphthalenedisulfonic acid, hydroxybenzenesulfonic acid, toluenesulfinic acid, benzenesulfinic acid, sulfanilic acid, sulfamic acid, α-resorcylic acid, β-resorcylic acid, γ-resorcylic acid, gallic acid, fluoroglycine, sulfosalicylic acid, ascorbic acid, erythorbic acid, bisphenolic acid, hydrochloric acid, nitric acid, sulfuric acid, phosphoric acid, polyphosphoric acid, boric acid, and boronic acid. The addition amount of the acid may be determined such that the surface pH of the image recording layer is adjusted to be from 3 to 8.

The above acid may be used in the form of a metal salt (for example, a salt of sodium, potassium, calcium, cesium, zinc, copper, iron, aluminum, zirconium, lanthanum, yttrium, magnesium, strontium, or cerium) or in the form of an amine salt (for example, ammonia, triethylamine, tributylamine, piperazine, 2-methylpiperazine, or polyallylamine).

The image recording layer in the present invention preferably contains a storability improving agent such as an ultraviolet absorber, an antioxidant, or a bleed inhibitor.

Examples of the ultraviolet absorber, antioxidant, and bleed inhibitor include an alkylated phenol compound (examples of which include a hindered phenol compound), an alkylthiomethylphenol compound, a hydroquinone compound, an alkylated hydroquinone compound, a tocopherol compound, a thiodiphenyl ether compound, a compound having two or more thioether bonds, a bisphenol compound, an O-benzyl compound, an N-benzyl compound, an S-benzyl compound, a hydroxybenzyl compound, a triazine compound, a phosphonate compound, an acylaminophenol compound, an ester compound, an amide compound, ascorbic acid, an amine antioxidant, a 2-(2-hydroxyphenyl)benzotriazole compound, a 2-hydroxybenzophenone compound, an acrylate, a water-soluble metal salt, a hydrophobic metal salt, an organometallic compound, a metal complex, a hindered amine compound (examples of which include a TEMPO compound), a 2-(2-hydroxyphenyl)-1,3,5-triazine compound, a metal deactivator, a phosphite compound, a phosphonite compound, a hydroxyamine compound, a nitroso compound, a peroxide scavenger, a polyamide stabilizer, a polyether compound, a basic auxiliary stabilizer, a nucleating agent, a benzofuranone compound, an indolinone compound, a phosphine compound, a polyamine compound, a thiourea compound, a urea compound, a hydrazide compound, an amidine compound, a sugar compound, a hydroxybenzoic acid compound, a dihydroxybenzoic acid compound, or a trihydroxybenzoic acid compound.

Among them, an alkylated phenol compound, a compound having two or more thioether bonds, a bisphenol compound, ascorbic acid, an amine antioxidant, a water-soluble metal salt, a hydrophobic metal salt, an organometallic compound, a metal complex, a hindered amine compound, a hydroxyamine compound, a polyamine compound, a thiourea compound, a hydrazide compound, a hydroxybenzoic acid compound, a dihydroxybenzoic acid compound, and a trihydroxybenzoic acid compound are preferable.

The additional components described above may be added to the image recording layer forming liquid. An additional component may be used singly, or two or more thereof may be used in combination. The additional components may be used in the form of an aqueous solution, a dispersion, a polymer dispersion, an emulsion, or oil droplets, or may be encapsulated in microcapsules. In the image recording layer in the present invention, the content of the additional components is preferably from 0.01 g/m² to 10 g/m².

When vapor-phase process silica is used as the inorganic fine particles, the silica surface may be processed with a silane coupling agent for the purpose of improving dispersibility of the vapor-phase process silica. As the silane coupling agent, a silane coupling agent having an organic functional group, in addition to a moiety that performs coupling, is preferable. Examples of such organic functional groups include a vinyl group, an amino group (a primary to tertiary amino group or a quaternary ammonium salt), an epoxy group, a mercapto group, a chloro group, an alkyl group, a phenyl group, and an ester group.

In the present invention, the image recording layer preferably contains an organic solvent having a high boiling point for prevention of curling of the image recording layer. The organic solvent having a high boiling point is an organic compound having a boiling point of 150° C. or higher under ordinary pressure, and may be a water-soluble compound or a hydrophobic compound. Such organic solvent having a high boiling point may be liquid or solid at room temperature, and may be a low molecular-weight compound or a high molecular-weight compound.

Specific examples of the organic solvent having a high boiling point include aromatic carboxylic acid esters (for example, dibutyl phthalate, diphenyl phthalate, and phenyl benzoate), aliphatic carboxylic acid esters (for example, dioctyl adipate, dibutyl sebacate, methyl stearate, dibutyl maleate, dibutyl fumarate, and acetylcitric acid triethyl ester), phosphoric esters (for example, trioctyl phosphate and tricresyl phosphate), epoxy compounds (for example, epoxidated soybean oil and epoxidated fatty acid methyl ester), alcohols (for example, stearyl alcohol, ethylene glycol, propylene glycol, diethylene glycol, triethylene glycol, glycerin, diethylene glycol monobutyl ether, triethylene glycol monobutyl ether, glycerin monomethyl ether, 1,2,3-butanetriol, 1,2,4-butanetriol, 1,2,4-pentanetriol, 1,2,6-hexanetriol, 1,2-hexanediol, thiodiglycol, triethanolamine, and polyethylene glycol), vegetable oils (for example, soy bean oil and sunflower oil), and higher aliphatic carboxylic acids (for example, linoleic acid and oleic acid).

Among them, diethylene glycol monobutyl ether, triethylene glycol monobutyl ether, and 1,2-hexanediol are particularly preferable from the viewpoints of improving ink absorption speed and preventing a decrease in image density.

The image recording layer in the present invention may contain polymer fine particle dispersion. The polymer fine particle dispersion is used for improving film physical properties such as stabilization of size, prevention of curling, prevention of adhesion, and prevention of film-cracking Description of polymer fine particle dispersions is found in JP-A Nos. 62-245258, 62-1316648, and 62-110066. When a dispersion of fine particles of a polymer having a low glass transition temperature (40° C. or lower) is contained in the image recording layer, cracking and curling of the layer may be prevented.

Additional Process

The method of producing a recording medium of the invention includes forming an image recording layer after the cooling-separation treatment, and may further include other additional processes as necessary.

After the formation of the image recording layer, the mage recording layer may be calendered by, for example, passing the substrate having the image recording layer through a nip between rolls under heat and pressure using a super calender, a gloss calender, or the like, whereby surface smoothness, glossiness, transparency, and film strength can be improved. However, the calender treatment sometimes decreases porosity of the image recording layer (which results in decrease in ink absorbency). Therefore, the calender treatment should be performed under conditions in which the porosity of the image recording layer is not largely decreased.

The roll temperature when the calender treatment is performed is preferably from 30° C. to 150° C., and more preferably from 40° C. to 100° C. The linear pressure applied between the rollers in the calender treatment is preferably from 50 kg/cm to 400 kg/cm (from 49 kN/m to 392 kN/m), and more preferably from 100 kg/cm to 200 kg/cm (from 98 kN/m to 196 kN/m).

In the above description, the recording medium according to the present invention is described mainly by way of a recording medium for inkjet recording (inkjet recording medium). However, media other than inkjet recording media such as those described below may be similarly produced, and improvement in surface gloss and image clarity and reduction in surface defects can be achieved.

Image Receiving Material for Electrophotography

An image receiving material for electrophotography includes a substrate and, as an image recording layer, at least one toner image receiving layer disposed on at least one surface of the substrate. The image receiving material for electrophotography may further include one or more other layers, which may be appropriately selected as necessary. Examples of the other layers include a surface protective layer, an intermediate layer, an undercoat layer, a cushioning layer, a charge adjusting layer (antistatic layer), a reflection layer, a color-tint adjusting layer, a storability-improving layer, an adhesion-preventing layer, an anti-curling layer, or a smoothing layer. These layers may each independently have a single-layer structure or a multilayer structure.

Silver-Salt Photographic Photosensitive Material

A silver-salt photographic photosensitive material may have, for example, a configuration in which photosensitive layers (recording layers), which form Y, M, and C (yellow, magenta, and cyan) colors, are provided as an image recording layer on a substrate. The silver-salt photographic photosensitive material may be a material for use in a silver halide photography in which color development, bleach fixation, washing with water, and drying are conducted, after printing exposure, by sequentially immersing the material in plural processing tanks so as to sequentially pass the material through the plural processing tanks and so as to obtain an image.

Thermal Transfer Image-Receiving Material

Examples of thermal transfer-image-receiving materials include a material which has a configuration including an image receiving layer as an image recording layer provided on a substrate, and which is used for a system in which a thermal transfer material including at least a thermally-meltable ink layer provided on a support is heated using a thermal head so as to melt-transfer an ink from the thermally-meltable ink layer.

Material for Thermosensitive Color-Formation Recording

Examples of materials for thermosensitive color-formation recording include a material which has a configuration including at least a thermal color-forming layer as an image recording layer provided on a substrate, and which is used for a thermo-autochrome system (TA system) whereby an image is formed by thermal color formation achieved by repetition of heating with a thermal head and fixation with ultraviolet rays or the like.

Sublimation Transfer Image-Receiving Material

Examples of sublimation transfer image-receiving materials include a material which has a configuration including at least an image receiving layer as the image recording layer provided on a substrate, and which is used for a sublimation transfer system involving heating of a sublimation transfer material including, on a support, at least an ink layer containing a thermal diffusive dye (sublimating dye) using a thermal head so as to transfer the thermal diffusive dye from the ink layer.

In the above-described inkjet recording medium, image receiving material for electrophotography, material for thermosensitive color-formation recording, sublimation transfer image-receiving material, thermal transfer image-receiving material, and silver-salt photographic photosensitive material, at least an image recording layer appropriate to each material (an ink receiving layer, a toner image receiving layer, a thermal color-forming layer, an image receiving layer, or a photosensitive layer) is provided on a substrate.

### EXAMPLES

In the following, the present invention is described in further detail with reference to examples. However, the examples should not be construed as limiting the present invention. The terms “part” and “%” are based on mass, unless indicated otherwise.

Base Paper

50 parts of LBKP obtained from acacia and 50 parts of LBKP obtained from aspen were respectively beaten using a double disc refiner to give a Canadian freeness of 300 mL, and thus a pulp slurry was prepared.

Subsequently, to the pulp slurry obtained as described above, 1.3% of cationic starch (trade name: CAT 0304L, manufactured by Nippon NSC, Ltd.), 0.15% of anionic polyacylamide (trade name: POLYACRON ST-13, manufactured by Seiko PMC Corporation), 0.29% of an alkyl ketene dimer (trade name: SIZEPINE K, manufactured by Arakawa Chemical Industries, Ltd.), 0.29% of epoxidated behenic acid amide, and 0.32% of polyamide-polyamine-epichlorohydrin (trade name: ARAFIX 100, manufactured by Arakawa Chemical Industries, Ltd.) were added, and thereafter 0.12% of a defoaming agent was added thereto. The percentages above are percentages relative to the pulp.

The pulp slurry prepared as described above was used for paper making using a Fourdrinier paper machine. The felt face of the web was pressed against a drum dry cylinder with a dryer canvas interposed therebetween at a tensile strength of the dryer canvas set at 1.6 kg/cm, thereby drying the web. Then, polyvinyl alcohol (trade name: KL-118, manufactured by Kuraray Co., Ltd.) was coated on both sides of the base paper in an amount of 1 g/m² by size press, and then dried and calendered. The base paper was formed to have a basis weight of 157 g/m², and thus a base paper having a thickness of 157 μm was obtained.

### Example 1

The wire face side of the obtained base paper was subjected to corona discharge treatment. Thereafter, polyethylene prepared by blending high density polyethylene (having a density of 0.96 g/cm³) and low density polyethylene (having a density of 0.90 g/cm³) at a mass ratio (high density polyethylene/low density polyethylene) of 8/2 was coated on the wire face in a coating amount of 13 g/m² by melt extrusion at a temperature of 320° C. using a melt extruder, whereby a polyethylene resin layer having a matte surface was formed. The thickness of the polyethylene resin layer was 13 μm.

Hereinafter, the surface having the polyethylene resin layer is referred to as a “rear face”, and the other surface is referred to as a “front face”.

The polyethylene resin layer on the rear face was subjected to a corona discharge treatment, and thereafter, a dispersion liquid prepared by dispersing aluminum oxide (trade name: ALUMINASOL 100, manufactured by Nissan Chemical Industries, Ltd.) and silicon dioxide (trade name: SNOWTEX O, manufactured by Nissan Chemical Industries, Ltd.) at a mass ratio of 1:2 as antistatic agents in water was coated in a dry mass of 0.2 g/m². As a result, a pigment-containing layer (which is referred to as a “back coat layer” hereinafter) was formed.

Subsequently, the front face was subjected to a corona discharge treatment, and then, polyethylene having a density of 0.93 g/cm³ which includes 10% by mass of titanium oxide was coated thereon in an amount of 18 g/m² by melt extrusion at a temperature of 320° C. using a melt extruder, whereby a polyethylene resin layer was formed. The thickness of the polyethylene resin layer was 18 μm.

Thereafter, the paper was processed using a cooling-separation-belt-fixing-smoother apparatus (an endless press) shown in FIG. 1, in such a manner that the front face contacted with the endless belt 2. In this process, the heating temperature was 110° C., and the cooling temperature was 40° C. Further, the conveyance speed of the belt at the time of applying heat and pressure and at the time of cooling was 20 mm/sec.

Here, the “heating temperature” means a temperature of a heating roller 3, and is measured using a non-contact thermometer. Further, the “cooling temperature” means a temperature of a portion of the endless belt 2 that contacts with the cooling device 7 described below, and is measured using a non-contact thermometer.

In the cooling-separation-belt-fixing-smoother apparatus (endless press) shown in FIG. 1, a processing section 1 is equipped with an endless belt 2, a heating roller 3, a pressurization roller 4, tension rollers 5, a cleaning roller 6, a cooling device 7, and conveyance rollers 8.

The heating roller 3 and a pair of tension rollers 5 are disposed at the inner side of the endless belt 2. The pair of tension rollers 5 is disposed at a distance from the heating roller 3. The endless belt 2 is rotatably stretched by the heating roller 3 and the tension rollers 5. The pressurization roller 4 is in contact with the outer circumferential surface of the endless belt 2 and, specifically, is disposed to face the heating roller 3 with the endless belt 2 therebetween. Pressure is applied to a portion of the endless belt 2 located between the pressurization roller 4 and the heating roller 3, by the pressurization roller 4 and the heating roller 3, thereby forming a nip portion. The cooling device 7 is disposed at the inner side of the endless belt 2. The cooling device 7 is positioned between the heating roller 3, which is positioned upstream (upstream in the conveyance direction of the endless belt 2), and the tension rollers 5, which are positioned downstream (downstream in the conveyance direction of the endless belt 2). The conveyance rollers 8, two in number, are disposed to face the cooling device 7 with the endless belt 2 therebetween. Here, the distance between the two conveyance rollers 8 is substantially equal to the distance between the nip portion and one of the conveyance rollers 8 close to the nip portion, and the distance between the other one of the conveyance rollers 8 and one of the tension rollers 5 closer thereto. The cleaning roller 6 is disposed at a side of the heating roller 3 opposite to the side at which the pressurization roller 4 is provided, and a portion of the endless belt 2 is present between the cleaning roller 6 and the heating roller 3. A pressure is applied to a portion of the endless belt 2 located between the cleaning roller 6 and the heating roller 3, by the cleaning roller 6 and the heating roller 3. The heating roller 3, the pressurization roller 4, the tension rollers 5, the cleaning roller 6, and the conveyance rollers 8 rotate synchronously, thereby allowing the endless belt 2 to rotate.

A substrate 10 processed in the processing section 1 is conveyed to the cooling device 7 after the temperature of the substrate 10 has reached the same temperature as the temperature of the heating roller 3. Further, the substrate 10 is cooled down to the same temperature as the temperature of the endless belt 2 cooled by the cooling device 7.

In the processing section 1, the surface roughness (arithmetic average roughness (Ra)) of the endless belt 2 was 0.8 μm, and the pressure between rollers (nip pressure) was 7.5 kgf/cm².

A belt prepared in the following manner was used as the belt member.

A primer for a silicone rubber, DY39-115 (trade name, manufactured by Dow Corning Toray Silicone Co., Ltd.), was coated on a base layer made of polyimide, and drying by air was performed for 30 minutes. After drying, the base layer was immersed in a coating liquid formed by 100 parts by mass of a silicone rubber precursor DY35-796AB (trade name, manufactured by Dow Corning Toray Silicone Co., Ltd., Japan) and 30 parts by mass of n-hexane, thereby forming a coating film. Then, the coating film was subjected to primary vulcanization at 120° C. for 10 minutes, whereby a silicone rubber layer having a thickness of 40 μm was formed.

On the silicone rubber layer, a coating liquid prepared from 100 parts by mass of a fluorocarbon siloxane rubber precursor SIFEL 610 (trade name, manufactured by Shin-Etsu Chemical Co., Ltd.) and 20 parts by mass of a mixed solvent of fluorine-containing solvents (m-xylene hexafluoride, perfluoroalkane, and perfluoro(2-butyltetrahydrofuran)) was coated by immersion to form a coating film. Then, the coating film was subjected to primary vulcanization at 120° C. for 10 minutes, and to secondary vulcanization at 180° C. for 4 hours. In this way, an endless belt having a 20 μm-thick fluorocarbon siloxane rubber layer was prepared.

Next, the front face was subjected to corona discharge treatment. Thereafter, the image recording layer forming liquid described below and the PAC (polyaluminum chloride) liquid described below were in-line blended, and the blended liquid was coated on the front surface using an extrusion die coater such that the coating amount of the image recording layer forming liquid was 146.4 g/m² and the PAC liquid was 9.1 g/m². Thereafter, the resulting coating layer was dried at 5° C. and 30% relative humidity using a cold air dryer (at an air flow rate of from 3 msec to 8 msec) for 5 minutes, and was further dried with a dry air having a temperature of 25° C. and a relative humidity of 25% (at an air flow rate of from 3 msec to 8 msec) for 20 minutes. Thereby, an image recording layer having a dry layer thickness of 30 μm was formed on the substrate.

Image Recording Layer Forming Liquid

According to the “composition of silica dispersion liquid” described below, silica fine particles were mixed with a liquid prepared by mixing dimethyldiallylammonium chloride polymer (trade name: SHALLOL DC-902P) with ion-exchange water. Then ZIRCOSOL ZA-30 (trade name) was further added to the resulting mixture. The resulting slurry was further subjected to dispersion using ULTIMIZER (trade name), manufactured by Sugino Machine Limited, under a pressure of 170 MPa, whereby a silica dispersion liquid including silica fine particles having a median diameter (an average particle diameter) of 120 nm was prepared.

According to the “composition of image recording layer forming liquid” described below, ion-exchange water, a 7.5% boric acid solution, SC-505 (trade name), a polyvinyl alcohol solution, and SUPERFLEX 650-5 (trade name) were sequentially added to the above silica dispersion liquid, followed by mixing, whereby an image recording layer forming liquid was prepared.

Composition of silica dispersion liquid

| | | |
|---|---|---|
| (1) | Vapor-phase silica fine particles (AEROSIL | 15.0 parts |
| | (registered trademark) 300SF75, manufactured | |
| | by Nippon Aerosil Co., Ltd.) | |
| (2) | Ion-exchange water | 82.9 parts |
| (3) | SHALLOL DC-902P (51.5% solution) (trade name, | 1.3 parts |
| | dispersant; manufactured by Dai-ichi Kogyo | |
| | Seiyaku Co., Ltd.) | |
| (4) | Zirconyl acetate (ZIRCOSOL ZA-30 (trade name), | 0.8 parts |
| | manufactured by Daiichi Kigenso Kagaku Kogyo | |
| | Co., Ltd., 50% solution) | |

Composition of Image Recording Layer Forming Liquid

| | | |
|---|---|---|
| (1) | Silica dispersion liquid | 59.5 parts |
| (2) | Ion-exchange water | 7.8 parts |
| (3) | 7.5% boric acid solution (crosslinking agent) | 4.4 parts |
| (4) | Dimethylamine/epichlorohydrin/polyalkylene | 0.1 parts |
| | polyamine polycondensate (50% solution), | |
| | (trade name: SC-505, manufactured by HYMO | |
| | Co., Ltd.) | |
| (5) | Polyvinyl alcohol solution described below | 26.0 parts |
| (6) | Cation-modified polyurethane | 2.2 parts |
| | (trade name, SUPERFLEX 650-5, manufactured | |
| | by Dai-Ichi Kogyo Seiyaku Co., Ltd. (25% | |
| | solution)) | |

Composition of Polyvinyl Alcohol Solution

| | | |
|---|---|---|
| (1) | Polyvinyl alcohol (PVA) | 6.96 parts |
| | (trade name: JM-33, manufactured by JAPAN | |
| | VAM & POVAL Co., Ltd., having a saponifi- | |
| | cation degree of 94.3 mol % and a polymeri- | |
| | zation degree of 3300) | |
| (2) | Polyoxyethylene lauryl ether | 0.23 parts |
| | (surfactant; trade name: EMULGEN 109P, | |
| | manufactured by Kao Corporation) | |
| (3) | Diethylene glycol monobutyl ether | 2.12 parts |
| | (trade name: BUTYCENOL 20P, manufactured by | |
| | Kyowa Hakko Chemical Co., Ltd.) | |
| (4) | Ion-exchange water | 90.69 parts |

Composition of PAC liquid

| | | |
|---|---|---|
| (1) | Polyaluminum chloride aqueous solution having a basicity | 20 parts |
| | of 83% (trade name: ALFINE 83, manufactured by Taimei | |
| | Chemical Co., Ltd.) | |
| (2) | Ion-exchange water | 80 parts |

Method of Evaluation

With regard to the following evaluation items, measurement and evaluation were performed as follows. Results are shown in Table 1.

### (1) Gloss

The gloss of a surface of the recording medium that has an image recording layer was measured at an incident angle of 60° and a light reception angle of 60° using a digital variable glossmeter, UGV-5D (trade name, manufactured by Suga Test Instruments Co., Ltd.; measurement pore: 8 mm).

Evaluation Criteria

AA: 50% or higher

A: 40% or higher but lower than 50%

B: 30% or higher but lower than 40%

C: lower than 30%

(2) Image Clarity

Based on the method of image clarity test defined in JIS H8686-2: 1999, the image clarity of a surface of the recording medium that has an image recording layer was measured using an image clarity meter, ICM-1 (trade name, manufactured by Suga Test Instruments Co., Ltd.) under the following measurement conditions.

Measurement Conditions
Measurement method: reflection
Measurement angle: 60°
Optical comb: 2.0 mm

Evaluation Criteria

A: 80% or higher

B: 70% or higher but lower than 80%

C: 30% or higher but lower than 70%

(3) Surface Defects

The surface conditions of a surface of the recording medium that has an image recording layer was visually observed, and the number of crack defects in an area of 100 m² was determined.

Evaluation Criteria

A: no crack is observed.

B: the number of cracks is one or two, which is practically acceptable.

C: the number of cracks is from three to ten, which is practically problematic.

(4) Blocking Resistance

The recording medium was cut into a size of 10 centimeters square, and was left to stand at 23° C. under an atmosphere of 80% RH for one day. Then, five sheets of the recording medium were piled up such that a surface of one sheet having an image recording layer and a surface of another sheet at a side opposite to the image recording layer side contacted with each other, and a load of 2 kg/m² was placed thereon. The stacked sheets in this state were stored at 40° C. under an atmosphere of 80% RH for one week. Thereafter, an average level of blocking was evaluated.

Evaluation Criteria

A: the sheets are separated with small force.

B: the sheets are not separated with small force.

### Example 2

Preparation of a Recording Medium was Conducted in the Same Manner as in Example 1, except that the formation of an image recording layer was conducted as described below. Evaluation was performed in the same manner as in Example 1. Results are shown in Table 1.

Formation of Image Recording Layer

The image recording layer forming liquid described below was cooled down to 50° C. Then, the image recording layer forming liquid was subjected to an ultrasonic defoaming treatment for 10 minutes while maintaining the temperature of the liquid at 50° C. Just after the completion of the ultrasonic defoaming treatment, the resulting image recording layer forming liquid was coated on the substrate such that the dry solid content of pheudoboehmite alumina became 13 g/m². After coating, the coating layer was set-dried for two minutes to have a film surface temperature of 20° C. Thereafter, the coating layer was dried at 80° C. for 10 minutes, whereby an image recording layer was formed. The film surface temperature was measured in a state in which the moisture content was 200 g/m², using a radiation thermometer.

Image Recording Layer Forming Liquid

708 g of CATALOID AP-5 (trade name, manufactured by Catalysts & Chemicals Industries, Co., Ltd.; pseudoboehmite alumina hydrate) was added to 2042 g of ion-exchange water while stirring using a dissolver, thereby obtaining a white coarse particle dispersion liquid of alumina. In this process, the rotation frequency of the dissolver was 3000 rpm and the rotation time was 10 minutes.

Then, the resulting alumina coarse particle dispersion liquid was finely dispersed using a high pressure disperser (ULTIMIZER HJP25005 (trade name), manufactured by Sugino Machine Limited) to obtain an alumina dispersion liquid which is white transparent and which has a solid content concentration of 25% (a white transparent alumina dispersion liquid). In this process, the pressure was 100 MPa, and the discharge amount was 600 g/min.

The particle diameter of dispersed particles in the obtained white transparent alumina dispersion liquid was measured as follows. The liquid temperature of the white transparent alumina dispersion liquid was adjusted to 30° C. Then, the dispersion liquid was diluted with ion-exchange water such that the transmittance as measured with LA-920 (trade name, manufactured by Horiba Ltd.) became 80%. In this diluted state, the particle size of dispersed particles was measured using LA-920 (trade name, manufactured by Horiba Ltd.). As a result, it was found that the average particle diameter was 0.1043 μm. The pH of the white transparent alumina dispersion liquid at a liquid temperature of 30° C. was measured using a pH meter, and was found to be 4.62. Further, the viscosity of the white transparent alumina dispersion liquid at 30° C. was measured using a B-type viscometer, and was found to be 40 mPa·s.

100 parts of the above white transparent alumina dispersion liquid, 34.6 parts of a 7% aqueous solution (an aqueous binder solution) of PVA-245 (trade name, manufactured by Kuraray Co., Ltd.; polyvinyl alcohol having a saponification degree of 88% and an average polymerization degree of 3500), 9.7 parts of a 7.5% aqueous solution of boric acid (an aqueous solution of crosslinking agent), 1.32 parts of a 10% aqueous solution of a surfactant (trade name: EMULGEN 109P, manufactured by Kao Corporation; HLB (Hydrophilic-Liphophilic Balance) value of 13.6; a surfactant), and 40.5 parts of ion-exchange water were each heated to 60° C. before mixing and were mixed thoroughly while maintaining the temperature at 60° C., whereby an image recording layer forming liquid was prepared. Here, a mass ratio (al/PVA) of alumina hydrate to PVA was 10.

The viscosity of the obtained image recording layer forming liquid at 30° C. was measured using a B-type viscometer, and was found to be 56 mPa·s.

### Example 3

Preparation of a Recording Medium was Conducted in the Same Manner as in Example 1, except that the heating temperature in the cooling-separation treatment was changed to 130° C. Evaluation was performed in the same manner as in Example 1. Results are shown in Table 1.

### Example 4

Preparation of a Recording Medium was Conducted in the Same Manner as in Example 1, except that the heating temperature in the cooling-separation treatment was changed to 90° C. Evaluation was performed in the same manner as in Example 1. Results are shown in Table 1.

### Example 5

Preparation of a Recording Medium was Conducted in the Same Manner as in Example 1, except that the “dispersion liquid prepared by dispersing aluminum oxide and silicon dioxide at a mass ratio of 1:2 in water” used in Example 1 was changed to the following “backside coating layer coating liquid”. Evaluation was performed in the same manner as in

### Example 1

### Results are Shown in Table 1

Backside Coating Layer Coating Liquid

14 parts of the following Component (A), 8 parts of the following Component (B), 6 parts of colloidal silica, and 20 parts of methanol were mixed. Further, water was added thereto to adjust the total amount to 100 parts.

Component (A)

In the presence of a reactive emulsifying agent (trade name: ADEKA REASOAP SE-10N, manufactured by Asahi Denka Kogyo Co., Ltd.), 62 parts of styrene, 5 parts of glycidyl methacrylate, 3 parts of acrylic acid, and 30 parts of 2-ethylhexyl acrylate were subjected to emulsion polymerization to obtain a water dispersion of a styrene-acrylic ester copolymer (Component (A)) having a solid content of 20% by mass.

Component (B)

A styrene-isoprene AB block copolymer (styrene/isoprene=80/20 (by mole ratio), weight average molecular weight: 7500) was sulfonated (to have a sulfonic acid content of 2 mmol/g), and was neutralized using sodium hydroxide to obtain a water-soluble polymer sodium salt (Component (B)).

### Example 6

Preparation of a Recording Medium was Conducted in the Same Manner as in Example 1, except that polypropylene was used instead of the “polyethylene prepared by blending high density polyethylene (having a density of 0.96 g/cm³) and low density polyethylene (having a density of 0.90 g/cm³) at a mass ratio (high density polyethylene/low density polyethylene) of 8/2” and “polyethylene having a density of 0.93 g/cm³”, and the heating temperature in the cooling-separation treatment was changed to 120° C. Evaluation was performed in the same manner as in Example 1. Results are shown in Table 1.

### Example 7

Preparation of a Recording Medium was Conducted in the Same Manner as in Example 1, except that the back coat layer formed on the rear face in Example 1 was not formed. Evaluation was performed in the same manner as in Example 1. Results are shown in Table 1.

### Example 8

Preparation of a Recording Medium was Conducted in the Same Manner as in Example 1, except that the image recording layer forming liquid and the PAC liquid in Example 1 were inline blended such that the coating amount of the image recording layer forming liquid was 73.2 g/m² and the coating amount of the PAC liquid was 4.6 g/m². Evaluation was performed in the same manner as in Example 1. Results are shown in Table 1.

### Comparative Example 1

Preparation of a Recording Medium was Conducted in the Same Manner as in Example 1, except that heating was not conducted in the cooling-separation treatment. Evaluation was performed in the same manner as in Example 1. Results are shown in Table 1.

### Comparative Example 2

Preparation of a Recording Medium was Conducted in the Same Manner as in Example 1, except that the heating temperature in the cooling-separation treatment was changed to 70° C. Evaluation was performed in the same manner as in Example 1. Results are shown in Table 1.

### Comparative Example 3

Preparation of a Recording Medium was Conducted in the Same Manner as in Example 1, except that the front face of the substrate was not subjected to the cooling-separation treatment, and that, after forming an image recording layer, the surface having the image forming layer was subjected to the cooling-separation treatment. Evaluation was performed in the same manner as in Example 1. Results are shown in Table 1.

### Comparative Example 4

Preparation of a Recording Medium was Conducted in the Same Manner as in Example 1, except that the heating temperature in the cooling-separation treatment was changed to 150° C. Evaluation was performed in the same manner as in Example 1. Results are shown in Table 1.

### Comparative Example 5

Preparation of a Recording Medium was Conducted in the Same Manner as in Example 1, except that the cooling temperature in the cooling-separation treatment was changed to 70° C. Evaluation was performed in the same manner as in Example 1. Results are shown in Table 1.

TABLE 1

| | | Example 1 | Example 2 | Example 3 | Example 4 | Example 5 | Example 6 | Example 7 |
|---|---|---|---|---|---|---|---|---|
| Resin Contained in Polyolefin | | Polyethylene | Polyethylene | Polyethylene | Polyethylene | Polyethylene | Polypropylene | Polyethylene |
| Resin Layer | | | | | | | | |
| Composition of Back Coat | | Aluminum | Aluminum | Aluminum | Aluminum | Latex/ | Aluminum | — |
| Layer | | oxide/ | oxide/silicon | oxide/ | oxide/ | silicon | oxide/silicon | |
| | | silicon | dioxide | silicon | silicon | dioxide | dioxide | |
| | | dioxide | | dioxide | dioxide | | | |
| Cooling- | Heating | 110 | 110 | 130 | 90 | 110 | 120 | 110 |
| Separation | Temperature | | | | | | | |
| Treatment | (° C.) | | | | | | | |
| | Cooling | 40 | 40 | 40 | 40 | 40 | 40 | 40 |
| | Temperature | | | | | | | |
| | (° C.) | | | | | | | |
| Composition | Inorganic | Vapor-phase | Pseudoboehmite | Vapor-phase | Vapor-phase | Vapor-phase | Vapor-phase | Vapor-phase |
| of Image | Fine Particles | process | alumina (13) | process | process | process | process silica | process |
| Recording | (Content) | silica (13) | | silica (13) | silica (13) | silica (13) | (13) | silica (13) |
| Layer | (g/m²) | | | | | | | |
| | Water-soluble | PVA | PVA | PVA | PVA | PVA | PVA | PVA |
| | Resin | | | | | | | |

| | | | | | | | |
|---|---|---|---|---|---|---|---|
| Gloss | A | AA | A | B | A | A | A |
| Image Clarity | A | A | B | B | A | A | A |
| Surface Defects | A | A | A | B | A | A | A |
| Blocking Resistance | A | A | A | A | A | A | B |

| | | | Comparative | Comparative | Comparative | Comparative | Comparative |
|---|---|---|---|---|---|---|---|
| | | Example 8 | Example 1 | Example 2 | Example 3 | Example 4 | Example 5 |
| Resin Contained in Polyolefin | | Polyethylene | Polyethylene | Polyethylene | Polyethylene | Polyethylene | Polyethylene |
| Resin Layer | | | | | | | |
| Composition of Back Coat Layer | | Aluminum | Aluminum | Aluminum | Aluminum | Aluminum | Aluminum |
| | | oxide/ | oxide/ | oxide/ | oxide/ | oxide/ | oxide/ |
| | | silicon | silicon | silicon | silicon | silicon | silicon |
| | | dioxide | dioxide | dioxide | dioxide | dioxide | dioxide |
| Cooling-Separation | Heating | 110 | — | 70 | 110 | 150 | 110 |
| Treatment | Temperature | | | | | | |
| | (° C.) | | | | | | |
| | Cooling | 40 | 40 | 40 | 40 | 40 | 70 |
| | Temperature | | | | | | |
| | (° C.) | | | | | | |
| Composition of | Inorganic | Vapor-phase | Vapor-phase | Vapor-phase | Vapor-phase | Vapor-phase | Vapor-phase |
| Image Recording | Fine Particles | process | process | process | process | process | process |
| Layer | (Content) | silica (13) | silica (13) | silica (13) | silica (13) | silica (13) | silica (13) |
| | (g/m²) | | | | | | |
| | Water-soluble | PVA | PVA | PVA | PVA | PVA | PVA |
| | Resin | | | | | | |

| | | | | | | |
|---|---|---|---|---|---|---|
| Gloss | A | C | C | C | C | C |
| Image Clarity | B | C | C | C | C | C |
| Surface Defects | A | C | C | C | C | A |
| Blocking Resistance | A | A | A | A | A | A |

Note):
In Comparative example 3, the front face of the substrate was not subjected to the cooling-separation treatment, and after forming an image recording layer, the surface having the image forming layer was subjected to the cooling-separation treatment.

As is shown in Table 1, all of the recording media prepared by the method of producing a recording medium of the present invention exhibited excellent gloss, excellent image clarity, and reduced surface defects. On the contrary, the recording media of Comparative examples were practically problematic due to inferior gloss, inferior image clarity, and surface defects.

According to the present invention, a method of producing a recording medium having excellent surface gloss, excellent image clarity, and reduced surface defects is provided.

Embodiments of the present invention include, but are not limited to, the following.

<1> A method of producing a recording medium, the method comprising:

providing a substrate, the substrate comprising a resin layer containing a polyolefin resin formed on one or both sides of a base paper;

subjecting a resin layer-side surface of the substrate to a cooling-separation treatment using a cooling-separation belt-fixing smoother apparatus, the apparatus comprising a heating and pressurizing unit and the unit comprising a belt member, by:
applying heat and pressure to the surface at a temperature of at least 80° C. and less than 140° C. using the heating and pressurizing unit;
cooling the surface to a temperature of 60° C. or lower; and
separating the surface from the belt member; and

forming an image recording layer on the resin layer-side surface of the substrate.

<2> The method of producing a recording medium according to <1>, wherein the resin layer is formed on both sides of the base paper.

<3> The method of producing a recording medium according to <2>, wherein the substrate further comprises a pigment-containing layer on the resin layer at one side of the substrate, and the image recording layer is formed on a surface at a side of the substrate not having the layer containing the pigment.

<4> The method of producing a recording medium according to any one of <1> to <3>, wherein the cooling-separation treatment is performed by applying heat and pressure to the substrate at a temperature of from 100° C. to 130° C.

<5> The method of producing a recording medium according to any one of <1> to <4>, wherein the cooling-separation treatment is performed by separating the recording medium after cooling to a temperature of from 25° C. to 60° C.

<6> The method of producing a recording medium according to any one of <1> to <5>, wherein the image recording layer comprises inorganic fine particles and a water-soluble resin.

<7> The method of producing a recording medium according to <6>, wherein an amount of the inorganic fine particles contained in the image recording layer is from 5 g/m² to 20 g/m².

<8> The method of producing a recording medium according to any one of <1> to <7>, further comprising subjecting the resin layer-side surface of the substrate to a corona discharge treatment after the cooling-separation treatment but before the forming of the image recording layer.

<9> The method of producing a recording medium according to any one of <6> to <8>, wherein the recording medium comprises a recording medium for use in inkjet recording.

<10> The method of producing a recording medium according to any one of <1> to <9>, wherein an amount of the polyolefin contained in the resin layer is from 5 g/m² to 30 g/m².

<11> The method of producing a recording medium according to any one of <3> to <10>, wherein an amount of the pigment contained in the layer containing the pigment is from 0.01 g/m² to 20 g/m².

All publications, patent applications, and technical standards mentioned in this specification are herein incorporated by reference to the same extent as if each individual publication, patent application, or technical standard was specifically and individually indicated to be incorporated by reference.

What is claimed is:

1. A method of producing a recording medium, the method comprising:
providing a substrate, the substrate comprising a resin layer containing a polyolefin resin formed on one or both sides of a base paper;
subjecting a resin layer-side surface of the substrate to a cooling-separation treatment using a cooling-separation belt-fixing smoother apparatus, the apparatus comprising a heating and pressurizing unit and the unit comprising a belt member, by:
applying heat and pressure to the surface at a temperature of at least 80° C. and less than 140° C. using the heating and pressurizing unit;
cooling the surface to a temperature of 60° C. or lower; and
separating the surface from the belt member; and
forming an image recording layer on the resin layer-side surface of the substrate.

2. The method of producing a recording medium according to claim 1, wherein the resin layer is formed on both sides of the base paper.

3. The method of producing a recording medium according to claim 2, wherein the substrate further comprises a pigment-containing layer on the resin layer at one side of the substrate, and the image recording layer is formed on a surface at a side of the substrate not having the layer containing the pigment.

4. The method of producing a recording medium according to claim 1, wherein the cooling-separation treatment is performed by applying heat and pressure to the substrate at a temperature of from 100° C. to 130° C.

5. The method of producing a recording medium according to claim 1, wherein the cooling-separation treatment is performed by separating the recording medium after cooling to a temperature of from 25° C. to 60° C.

6. The method of producing a recording medium according to claim 1, wherein the image recording layer comprises inorganic fine particles and a water-soluble resin.

7. The method of producing a recording medium according to claim 6, wherein an amount of the inorganic fine particles contained in the image recording layer is from 5 g/m² to 20 g/m².

8. The method of producing a recording medium according to claim 1, further comprising subjecting the resin layer-side surface of the substrate to a corona discharge treatment after the cooling-separation treatment but before the forming of the image recording layer.

9. The method of producing a recording medium according to claim 6, wherein the recording medium comprises a recording medium for use in inkjet recording.

10. The method of producing a recording medium according to claim 1, wherein an amount of the polyolefin contained in the resin layer is from 5 g/m² to 30 g/m².

11. The method of producing a recording medium according to claim 3, wherein an amount of the pigment contained in the layer containing the pigment is from 0.01 g/m² to 20 g/m².
